(19) United States
(12) Patent Application Publication
(10) Pub. No.: US 2025/0373466 A1
(43) Pub. Date: Dec. 4, 2025

(54) METHOD FOR IMPLEMENTING INTERCONNECTION AND INTERWORKING, ELECTRONIC DEVICE, AND COMPUTER-READABLE MEDIUM

(71) Applicant: CRSC COMMUNICATION & INFORMATION GROUP COMPANY LTD., Beijing (CN)

(72) Inventors: Jing LUO, Beijing (CN); Dongtao YANG, Beijing (CN); Shiyang XING, Beijing (CN); Tao ZHANG, Beijing (CN); Lijiao ZHANG, Beijing (CN)

(21) Appl. No.: 18/878,047

(22) PCT Filed: Jun. 27, 2023
(86) PCT No.: PCT/CN2023/102824

§ 371 Date: Dec. 22, 2024

(30) Foreign Application Priority Data
Feb. 24, 2023 (CN) 202310191791.X

(51) Int. Cl. H04L 12/46; H04L 69/18

(52) U.S. Cl. CPC H04L 12/46; H04L 69/18

(57) ABSTRACT

The present disclosure provides a method for implementing interconnection and interworking, an electronic device, and a computer-readable medium. The method is applied to a regional node having a first management unit, and includes: according to a preset first correspondence between ports and protocol versions and by a first target port, implementing interconnection and interworking with a first-level access node by adopting a protocol version corresponding to the first-level access node, where the first target port has the first correspondence with the protocol version corresponding to the first-level access node; and according to the first correspondence between ports and protocol versions and by a second target port, implementing interconnection and interworking with a core node having a second management unit by adopting a protocol version corresponding to the core node, where the second target port is a port having the first correspondence with the protocol version corresponding to the core node.

The present disclosure claims priority from the Chinese patent application entitled “METHOD FOR IMPLEMENTING INTERCONNECTION AND INTERWORKING, ELECTRONIC DEVICE, AND COMPUTER-READABLE MEDIUM” with an application date of Feb. 24, 2023 and an application No. 202310191791.X, the entirety of which is incorporated herein by reference.

### TECHNICAL FIELD

Embodiments of the present disclosure relate to the technical field of video surveillance, and particularly relate to a method for implementing interconnection and interworking, an electronic device, and a computer-readable medium.

### BACKGROUND

With the development of the video surveillance system technology and the development and changes in requirements of various railway departments, a technical specification for a railway integrated video surveillance system is constantly improved and optimized in various aspects such as system design, product manufacturing, operation maintenance, acceptance test, interconnection and interworking, and the like, so as to improve the overall performance of the railway integrated video surveillance system. Currently, completely standardized railway video surveillance systems have been achieved, and the formation of the railway video technical specification goes through a development process from pure function agreements to function plus protocol dual agreements, that is, from Transportation Based Communications No. 630-Technical Specification for Railway Integrated Video Surveillance System (Trial), referred to as Document 630 for short, to Technical Specification for Railway Integrated Video Surveillance System (V1.0), referred to as Document 71 for short, and then to the current QCR575-2017 Technical Specification for Railway Video Surveillance System, referred to as Document 575 for short.

With the continuous upgrading and improving of the railway video surveillance technical specification, as well as iterative upgrading and retrofit of existing railway video systems, the interconnection and interworking among nodes of multiple manufacturers, multiple systems and multiple standard protocols has become a normal state. Therefore, ensuring smooth interconnection and iteration of the railway video surveillance system is a basic principle of the integrated video surveillance system. Therefore, when the current mode of docking the Document 630 standard protocol with the Document 71 standard protocol is adopted, that is, when cascaded connection between a node of the Document 71 standard protocol and a node of the Document 575 standard protocol is implemented in an interface plus protocol converter mode: the following problems will occur:
(1) when cascaded connection between different levels of nodes of different non-standard protocols is implemented in the interface plus protocol converter mode, an interface service module and a protocol conversion module are required, which involves more intermediate modules and additional equipment investment cost;
(2) there are conventional problems like limitations of a single protocol proxy and step-by-step forwarding, and a constrained upgrading and retrofit hierarchical position under a three-level architecture mode, which may have certain influences on other systems originally cascaded, and
(3) interconnection and interworking of various levels of nodes involves a relatively complex operation flow, relatively high investment on personnel development and railway upgrading and retrofit, relatively high difficulties in troubleshooting, and relatively high daily maintenance cost.

### SUMMARY

Embodiments of the present disclosure provide a method for implementing interconnection and interworking, an electronic device, and a computer-readable medium.

In a first aspect, an embodiment of the present disclosure provides a method for implementing interconnection and interworking, which is applied to a regional node having a first management unit and includes: according to a preset first correspondence relationship between ports and protocol versions and by means of a first target port, implementing interconnection and interworking with a first-level access node by adopting a protocol version corresponding to the first-level access node, wherein the first target port is a port having the first correspondence relationship with the protocol version corresponding to the first-level access node; and according to the preset first correspondence relationship between ports and protocol versions and by means of a second target port, implementing interconnection and interworking with a core node having a second management unit by adopting a protocol version corresponding to the core node, wherein the second target port is a port having the first correspondence relationship with the protocol version corresponding to the core node.

In some exemplary embodiments, according to the preset first correspondence relationship between the ports and the protocol versions and by means of the first target port, implementing interconnection and interworking with the first-level access node by adopting the protocol version corresponding to the first-level access node includes: by means of the first target port, receiving a first registration request sent from the first-level access node by adopting the protocol version corresponding to the first-level access node, wherein the first registration request includes: information of the first-level access node; checking the information of the first-level access node; under the condition that the checking is passed, storing a second correspondence relationship between the information of the first-level access node and the first target port; and by means of the first target port, returning a first registration success response to the first-level access node by adopting the protocol version corresponding to the first-level access node.

In some exemplary embodiments, the information of the first-level access node includes: an identification of the first-level access node, an internet protocol address of the first-level access node, a port number of the first-level access node, a node name of the first-level access node, and a password of the first-level access node.

In some exemplary embodiments, according to the preset first correspondence relationship between the ports and the protocol versions and by means of the second target port, implementing interconnection and interworking with the core node having the second management unit by adopting the protocol version corresponding to the core node includes: by means of the second target port, sending a second registration request to the core node by adopting the protocol version corresponding to the core node, wherein the second registration request includes: information of the regional node; and by means of the second target port, receiving a second registration success response or a second registration failure response sent from the core node by adopting the protocol version corresponding to the core node.

In some exemplary embodiments, the information of the regional node includes: an identification of the regional node, an internet protocol address of the regional node, a port number of the regional node, a node name of the regional node, and a password of the regional node.

In some exemplary embodiments, according to the preset first correspondence relationship between the ports and the protocol versions and by means of the second target port, implementing interconnection and interworking with the core node having the second management unit by adopting the protocol version corresponding to the core node includes: by means of the second target port, receiving a control instruction issued by the core node by adopting the protocol version corresponding to the core node, wherein the control instruction includes: an identification of the first-level access node; and according to the preset first correspondence relationship between the ports and the protocol versions and by means of the first target port, implementing interconnection and interworking with the first-level access node by adopting the protocol version corresponding to the first-level access node includes: searching, in the pre-stored second correspondence relationship between the information of the first-level access node and the first target port, for a first target port corresponding to the information of the first-level access node including the identification of the first-level access node, and by means of the found first target port, issuing the control instruction to the first-level access node corresponding to the information of the first-level access node including the identification of the first-level access node by adopting a protocol version having the first correspondence relationship with the found first target port.

In some exemplary embodiments, according to the preset first correspondence relationship between the ports and the protocol versions and by means of the first target port, implementing interconnection and interworking with the first-level access node by adopting the protocol version corresponding to the first-level access node includes: by means of the first target port, receiving a first resource reporting request sent from the first-level access node by adopting the protocol version corresponding to the first-level access node, wherein the first resource reporting request includes: an identification of the first-level access node, and resource information of a second-level access node corresponding to the first-level access node; storing a third correspondence relationship between the identification of the first-level access node and the resource information of the second-level access node corresponding to the first-level access node; and by means of the first target port, sending a first reporting success response to the first-level access node by adopting the protocol version corresponding to the first-level access node.

In some exemplary embodiments, according to the preset first correspondence relationship between the ports and the protocol versions and by means of the second target port, implementing interconnection and interworking with the core node having the second management unit by adopting the protocol version corresponding to the core node includes: by means of the second target port, sending a second resource reporting request to the core node by adopting the protocol version corresponding to the core node, wherein the second resource reporting request includes: an identification of the regional node, and resource information of a second-level access node corresponding to a first-level access node corresponding to the regional node; and by means of the second target port, receiving a second reporting success response sent from the core node by adopting the protocol version corresponding to the core node.

In a second aspect, an embodiment of the present disclosure provides a method for implementing interconnection and interworking, which is applied to a first-level access node and includes: implementing interconnection and interworking with a first target port of a regional node having a first management unit by adopting a protocol version corresponding to the first-level access node, wherein the first target port is a port having a first correspondence relationship with the protocol version corresponding to the first-level access node, and the first correspondence relationship is a correspondence relationship between ports and protocol versions of the regional node.

In some exemplary embodiments, implementing interconnection and interworking with the first target port of the regional node having the first management unit by adopting the protocol version corresponding to the first-level access node includes: sending a first registration request to the first target port of the regional node by adopting the protocol version corresponding to the first-level access node, wherein the first registration request includes: information of the first-level access node; and receiving a first registration success response or a first registration failure response sent from the first target port of the regional node by adopting the protocol version corresponding to the first-level access node.

In some exemplary embodiments, implementing interconnection and interworking with the first target port of the regional node having the first management unit by adopting the protocol version corresponding to the first-level access node includes: receiving a control instruction issued by the first target port of the regional node by adopting the protocol version corresponding to the first-level access node.

In some exemplary embodiments, implementing interconnection and interworking with the first target port of the regional node having the first management unit by adopting the protocol version corresponding to the first-level access node includes: sending a first resource reporting request to the first target port of the regional node by adopting the protocol version corresponding to the first-level access node, wherein the first resource reporting request includes: an identification of the first-level access node, and resource information of a second-level access node corresponding to the first-level access node; and receiving a first reporting success response sent from the first target port of the regional node by adopting the protocol version corresponding to the first-level access node.

In a third aspect, an embodiment of the present disclosure provides a method for implementing interconnection and interworking, which is applied to a core node having a second management unit and includes: implementing interconnection and interworking with a second target port of a regional node having a first management unit by adopting a protocol version corresponding to the core node, wherein the second target port is a port having a first correspondence relationship with the protocol version corresponding to the core node, and the first correspondence relationship is a correspondence relationship between ports and protocol versions of the regional node.

In some exemplary embodiments, implementing interconnection and interworking with the second target port of the regional node having the first management unit by adopting the protocol version corresponding to the core node includes: receiving a second registration request sent from the second target port of the regional node by adopting the protocol version corresponding to the core node, wherein the second registration request includes: information of the regional node; checking the information of the regional node; under the condition that the checking is passed, storing a fourth correspondence relationship between the information of the regional node and the second target port; and by means of the second target port, returning a second registration success response to the core node by adopting the protocol version corresponding to the core node.

In some exemplary embodiments, implementing interconnection and interworking with the second target port of the regional node having the first management unit by adopting the protocol version corresponding to the core node includes: determining the regional node according to a preset fifth correspondence relationship between first-level access nodes and regional nodes; and issuing a control instruction to the second target port of the regional node by adopting the protocol version corresponding to the core node, wherein the control instruction includes: an identification of the first-level access node.

In some exemplary embodiments, implementing interconnection and interworking with the second target port of the regional node having a first management unit by adopting the protocol version corresponding to the core node includes: receiving a second resource reporting request sent from the second target port of the regional node by adopting the protocol version corresponding to the core node, wherein the second resource reporting request includes: an identification of the regional node, and resource information of a second-level access node corresponding to a first-level access node corresponding to the regional node; and storing a sixth correspondence relationship between the identification of the regional node and the resource information of the second-level access node corresponding to the first-level access node corresponding to the regional node; and sending a second reporting success response to the second target port of the regional node by adopting the protocol version corresponding to the core node.

In a fourth aspect, an embodiment of the present disclosure provides an electronic device, including: at least one processor; and a memory having at least one program stored thereon which, when executed by the at least one processor, causes the at least one processor to implement any method for implementing interconnection and interworking as described above.

In a fifth aspect, an embodiment of the present disclosure provides a computer-readable medium having a computer program stored thereon which, when executed by a processor, causes any method for implementing interconnection and interworking as described above to be implemented.

Based on a first correspondence relationship between ports and protocol versions and by means of a first target port having the first correspondence relationship with a protocol version corresponding to a first-level access node, the method for implementing interconnection and interworking provided in the embodiment of the present disclosure implements interconnection and interworking between the first-level access node and the regional node by adopting a protocol version corresponding to the first-level access node, which means that the interconnection and interworking between a first-level access node and a regional node of different protocol versions can be implemented by adopting different protocol versions corresponding to different ports. Likewise, based on the first correspondence relationship between ports and protocol versions and by means of a second target port having the first correspondence relationship with a protocol version corresponding to a core node, the method of the present disclosure implements interconnection and interworking between the core node and the regional node by adopting a protocol version corresponding to the core node, which means that the interconnection and interworking between a core node and a regional node of different protocol versions can be implemented by adopting different protocol versions corresponding to different ports. Therefore, compared with the interface plus protocol converter mode, the method of the present disclosure does not need any other additional interface service module or protocol conversion module, or any other additional dedicated device, so that in terms of development and maintenance, development of the system can be ensured to be available, the research, development, operation and maintenance cost is reduced, and the management and maintenance of the protocol version are facilitated. Further, the number of intermediate modules is reduced, that is, the equipment investment cost is reduced, while the reduced number of intermediate modules means reduced fault points and reduced problem troubleshooting links, so that a problem can be located quickly. Further, a peer-to-peer protocol version can be selected autonomously to realize the function of cascaded connection, thereby reducing the influence of the constrained cascaded position and enabling higher adaptability. Further, timely response of the system is improved while the engineering deployment complexity is reduced, the user experience is greatly improved, and a good foundation is laid for an intelligent video surveillance system in the future.

### BRIEF DESCRIPTION OF DRAWINGS

Accompanying drawings are provided for further understanding of the embodiments of the present disclosure and constitute a part of the specification. Hereinafter, these drawings are intended to explain the present disclosure together with the following embodiments, but should not be considered as a limitation to the present disclosure. Detailed exemplary embodiments are described with reference to the accompanying drawings, in which:

FIG. 1 is a schematic diagram of a three-level architecture in the existing art;

FIG. 2 is a schematic diagram illustrating interconnection and interworking among nodes after the China State Railway Group Co., Ltd. (China Railway) upgrades to Document 71 standard protocol in the existing art;

FIG. 3 is a flowchart of a method for implementing interconnection and interworking applied to a regional node having a first management unit according to an embodiment of the present disclosure;

FIG. 4 is a flowchart of a method for implementing interconnection and interworking applied to a first-level access node according to another embodiment of the present disclosure;

FIG. 5 is a flowchart of a method for implementing interconnection and interworking applied to a core node having a second management unit according to another embodiment of the present disclosure;

FIG. 6 is a block diagram of an electronic device according to another embodiment of the present disclosure; and

FIG. 7 is a block diagram of a system for implementing interconnection and interworking according to another embodiment of the present disclosure.

### DETAIL DESCRIPTION OF EMBODIMENTS

To improve understanding of the technical solutions of the present disclosure for those skilled in the art, the method for implementing interconnection and interworking, the electronic device, and the computer-readable storage medium of the present disclosure will be described below in detail in conjunction with the accompanying drawings.

Exemplary embodiments will be described more sufficiently below with reference to the accompanying drawings, but which may be embodied in different forms and should not be construed as limited to the embodiments set forth herein. Rather, these embodiments are provided so that the present disclosure will be thorough and complete, and will fully convey the scope of the present disclosure to those skilled in the art.

The embodiments of the present disclosure and features thereof may be combined with each other as long as they are not contradictory.

As used herein, the term “and/or” includes any and all combinations of at least one associated listed item.

The terminology used herein is for the purpose of describing specific embodiments only and is not intended to limit the present disclosure. As used herein, the singular forms “a”, “an” and “the” are intended to include the plural forms as well, unless the context clearly indicates otherwise. It will be further understood that as used herein, the terms “comprise” and/or “consist of . . . ” specify the presence of the stated features, integers, steps, operations, elements, and/or components, but do not preclude the presence or addition of at least one other feature, integer, step, operation, element, component, and/or group thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the existing art and the present disclosure, and will not be interpreted in an idealized or overly formal sense unless expressly so defined herein.

Document 630 mainly specifies requirements on functions of railway integrated video surveillance, but not on a cascade protocol layer. Therefore, although the video surveillance systems of various manufacturers functionally meet the requirements of Document 630, obstacles still appear in the cascaded connection, and there is no standardized protocol or interface that can guide smooth interconnection among nodes of different video manufacturers. Therefore, at that time, the interconnection and interworking of different levels of nodes is based on an upper node, where the upper node opens a cascade protocol interface library, and a lower node manufacturer develops a corresponding interface module according to the cascade protocol interface library opened by the upper node to complete interconnection and interworking.

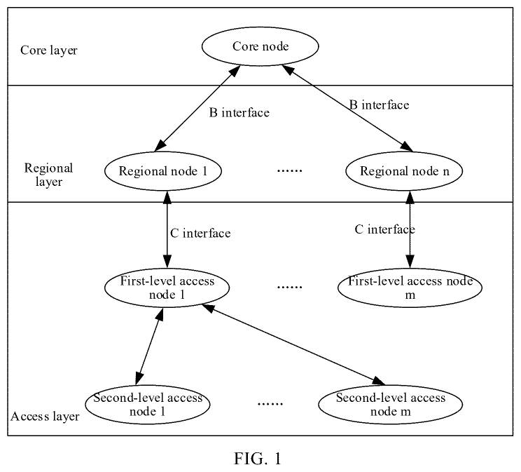

The release and implementation of Document 71 completely fills the blank of standardized cascade protocol guidance, and since then, railway video surveillance has entered an era of total digitalization. According to the Document 71 standard protocol, the cascaded connection between upper and lower nodes is divided into a C interface and a B interface according to a three-level architecture (access layer-regional layer-core layer) as shown in FIG. 1.

The C interface guides to implement interconnection and interworking between an access node and a regional node, and the B interface guides to implement interconnection and interworking between a regional node and a core node. For different video manufacturers each meeting the Document 71 standard protocol, cascaded connection can be completed smoothly without obstacles. However, due to the presence of access nodes and regional nodes under the Document 630 standard protocol, the access mode of accessing a lower node under the Document 630 standard protocol through interface and protocol converter is still required to be reserved when the upper node is upgraded to a Document 71 node.

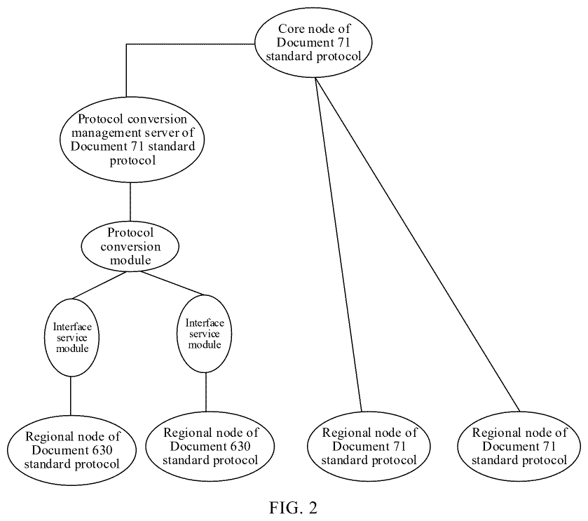

From Document 630 to Document 71, protocol guidance and conventions are provided for railway video surveillance systems, and a complete renewal of railway video surveillance systems has started. Up to now, China Railway and its eighteen railway bureaus have all updated to the Document 71 standard protocol. In this process, the interconnection and interworking among nodes after China Railway upgrades its integrated video surveillance system to the Document 71 standard protocol is taken as an example and shown in FIG. 2.

As can be seen from FIG. 2, a lower node that meets the original Document 630 standard protocol implements intercommunication and interworking with an upper node under the Document 71 standard protocol in an interface plus protocol converter mode. In other words, an interface service module reports data of a lower node under the Document 630 standard protocol to a protocol conversion module, which then forwards the data to an upper node under the Document 71 standard protocol according to a protocol attribute of the upper node. When the upper node issues an instruction, the instruction is firstly converted into an instruction corresponding to the protocol of the lower node by the protocol conversion module, and then the converted instruction is issued to the interface service module which further sends the converted instruction to the lower node. For a regional node meeting or upgraded to the Document 71 standard protocol, the regional node may be directly interconnected and interworked with the core node. An access node may access a regional node in the same mode. It can be seen from this process that when different levels of systems of different non-standard protocols are cascaded, there are many intermediate modules, and an interface service module and a protocol conversion module are required to implement interconnection and interworking of different levels of nodes, which further increases the equipment cost and brings great inconvenience to daily maintenance of the system.

Currently, the railway integrated video surveillance system has entered an era of comprehensive popularization of Document 575, and the construction, upgrading and retrofit of the integrated video surveillance system has entered a second stage. On the basis of Document 71, the release and implementation of Document 575 expands and modifies relevant protocol interfaces and fields of the C interface, and cancels the B interface originally used for interconnection of the regional node and the core node, while still implements interconnection and interworking of the regional node and the core node via the C interface. However, as can be seen from a comparison with the schematic diagram of nodes after the China Railway upgrades its video platform to the Document 71 standard protocol in FIG. 2, if the cascaded connection between the Document 71 standard platform and the Document 575 standard platform is still implemented in the interface plus protocol converter mode, each video manufacturer has to increase the corresponding investment on personnel development and code maintenance, which is a burden or even disaster for the development, upgrading, maintenance and troubleshooting of the railway video surveillance system.

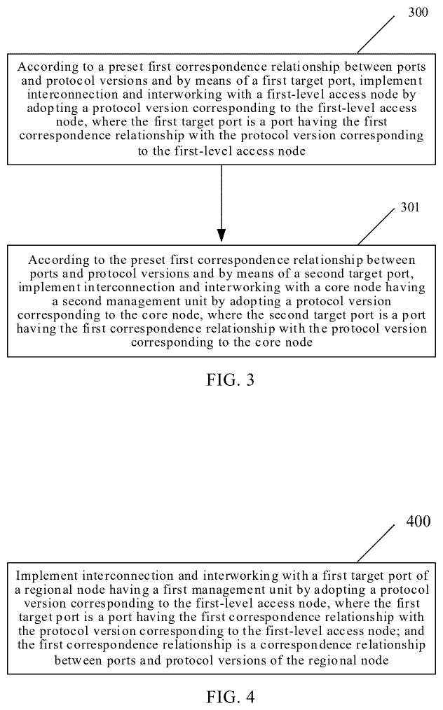

FIG. 3 is a flowchart of a method for implementing interconnection and interworking applied to a regional node having a first management unit according to an embodiment of the present disclosure.

In a first aspect, referring to FIG. 3, an embodiment of the present disclosure provides a method for implementing interconnection and interworking, which is applied to a regional node having a first management unit and includes the following steps 300 to 301.

At step 300, according to a preset first correspondence relationship between ports and protocol versions and by means of a first target port, implementing interconnection and interworking with a first-level access node by adopting a protocol version corresponding to the first-level access node, where the first target port is a port having the first correspondence relationship with the protocol version corresponding to the first-level access node.

In some exemplary embodiments, the protocol version may be at least one of: Document 71 standard protocol, Document 575 standard protocol, or Document 630 standard protocol. For example, the Document 71 standard protocol corresponds to a first target port 1001, the Document 575 standard protocol corresponds to a first target port 1002, the Document 630 standard protocol corresponds to a first target port 1003, and the Document 630 standard protocol may also be interconnected and interworked with the first target port 1001 corresponding to the Document 71 standard protocol in an interface plus protocol converter mode.

In some exemplary embodiments, the interconnection and interworking process between the first-level access node and the regional node mainly includes: a process of the first-level access node registering to the regional node, a process of the first-level access node reporting resource information to the regional node, and a process of the regional node issuing a control instruction to the first-level access node. These processes are described in detail below.

(I). The process of the first-level access node registering to the regional node.

In some exemplary embodiments, according to a preset first correspondence relationship between ports and protocol versions and by means of a first target port, implementing interconnection and interworking with the first-level access node by adopting the protocol version corresponding to the first-level access node includes: by means of the first target port, receiving a first registration request sent from the first-level access node by adopting the protocol version corresponding to the first-level access node, where the first registration request includes: information of the first-level access node; checking the information of the first-level access node; under the condition that the checking is passed, storing a second correspondence relationship between the information of the first-level access node and the first target port; and by means of the first target port, returning a first registration success response to the first-level access node by adopting the protocol version corresponding to the first-level access node.

In some exemplary embodiments, under the condition that the checking is not passed, by means of the first target port, a first registration failure response is returned to the first-level access node by adopting the protocol version corresponding to the first-level access node.

In some exemplary embodiments, the first registration request includes a session initiation protocol (SIP) header, and a first message body containing information of the first-level access node.

In some exemplary embodiments, the SIP header includes a destination port, i.e., the first target port.

In some exemplary embodiments, the first message body further includes: a message body version, an encoding mode, and information about whether the first message body is independent.

In some exemplary embodiments, the information of the first-level access node includes: an identification of the first-level access node, an internet protocol (IP) address of the first-level access node, a port number of the first-level access node, a node name of the first-level access node, and a password of the first-level access node.

In some exemplary embodiments, the information of the first-level access node further includes at least one of: a manufacturer identification, a manufacturer name, a protocol version, or a software version of the first-level access node.

In some exemplary embodiments, checking the information of the first-level access node includes: under the condition that information allocated to the first-level access node is the same as the information of the first-level access node in the first registration request, determining that the checking is passed; and under the condition that information allocated to the first-level access node is not the same as the information of the first-level access node in the first registration request, determining that the checking is not passed.

In some exemplary embodiments, the information allocated to the first-level access node includes: an identification allocated to the first-level access node, an IP address allocated to the first-level access node, a port number allocated to the first-level access node, a node name allocated to the first-level access node, and a password allocated to the first-level access node.

In some exemplary embodiments, the condition that information allocated to the first-level access node is the same as the information of the first-level access node in the first registration request includes: the identification allocated to the first-level access node is the same as the identification of the first-level access node in the information of the first-level access node contained in the first registration request, the IP address allocated to the first-level access node is the same as the IP address of the first-level access node in the information of the first-level access node contained in the first registration request, the port number allocated to the first-level access node is the same as the port number of the first-level access node in the information of the first-level access node contained in the first registration request, the node name allocated to the first-level access node is the same as the node name of the first-level access node in the information of the first-level access node contained in the first registration request, and the password allocated to the first-level access node is the same as the password of the first-level access node in the information of the first-level access node contained in the first registration request.

In some exemplary embodiments, the condition that information allocated to the first-level access node is not the same as the information of the first-level access node in the first registration request includes: the identification allocated to the first-level access node is not the same as the identification of the first-level access node in the information of the first-level access node contained in the first registration request, or the IP address allocated to the first-level access node is not the same as the IP address of the first-level access node in the information of the first-level access node contained in the first registration request, or the port number allocated to the first-level access node is not the same as the port number of the first-level access node in the information of the first-level access node contained in the first registration request, or the node name allocated to the first-level access node is not the same as the node name of the first-level access node in the information of the first-level access node contained in the first registration request, or the password allocated to the first-level access node is not the same as the password of the first-level access node in the information of the first-level access node contained in the first registration request.

In some exemplary embodiments, the first registration success response includes: a keep-alive period.

(II). The process of the regional node issuing a control instruction to the first-level access node.

In some exemplary embodiments, according to a preset first correspondence relationship between ports and protocol versions and by means of a first target port, implementing interconnection and interworking with the first-level access node by adopting the protocol version corresponding to the first-level access node includes: searching, in the pre-stored second correspondence relationship between the information of the first-level access node and the first target port, for a first target port corresponding to the information of the first-level access node including the identification of the first-level access node, and by means of the found first target port, issuing the control instruction to the first-level access node corresponding to the information of the first-level access node including the identification of the first-level access node by adopting the protocol version having the first correspondence relationship with the found first target port.

In some exemplary embodiments, the control instruction includes at least one of: a video request type instruction, a cloud mirror control type instruction, or a video playing control type instruction.

In some exemplary embodiments, the second correspondence relationship may be a second correspondence relationship stored during the registration process.

(III). The process of the first-level access node reporting resource information to the regional node.

In some exemplary embodiments, according to a preset first correspondence relationship between ports and protocol versions and by means of a first target port, implementing interconnection and interworking with the first-level access node by adopting the protocol version corresponding to the first-level access node includes: by means of the first target port, receiving a first resource reporting request sent from the first-level access node by adopting the protocol version corresponding to the first-level access node, where the first resource reporting request includes: an identification of the first-level access node, and resource information of a second-level access node corresponding to the first-level access node; storing a third correspondence relationship between the identification of the first-level access node and the resource information of the second-level access node corresponding to the first-level access node; and by means of the first target port, sending a first reporting success response to the first-level access node by adopting the protocol version corresponding to the first-level access node.

In some exemplary embodiments, the first resource reporting request includes: a SIP header and a third message body.

In some exemplary embodiments, the third message body includes: an identification of the first-level access node, and resource information of a second-level access node corresponding to the first-level access node.

In some exemplary embodiments, the third message body further includes: a message body version, an encoding mode, and information about whether the third message body is independent.

In some exemplary embodiments, the third message body further includes: a total number of packets and a current number of packets.

In some exemplary embodiments, the third message body may include resource information of one second-level access node, or may include resource information of two or more second-level access nodes.

In some exemplary embodiments, the resource information of the second-level access node includes: a resource identification, a resource name, resource installation position information in the second-level access node, use information of the second-level access node, and remark information of the second-level access node.

In some exemplary embodiments, the second-level access node corresponding to the first-level access node refers to a second-level access node connected to the first-level access node.

In some exemplary embodiments, the second-level access node may be a camera or the like.

In some exemplary embodiments, the resource of the second-level access node may be at least one of a camera resource, a user resource, or an alert resource.

At step 301, according to the preset first correspondence relationship between ports and protocol versions and by means of a second target port, implementing interconnection and interworking with a core node having a second management unit by adopting a protocol version corresponding to the core node, where the second target port is a port having the first correspondence relationship with the protocol version corresponding to the core node.

In some exemplary embodiments, the protocol version may be at least one of: Document 71 standard protocol, Document 575 standard protocol, or Document 630 standard protocol. For example, the Document 71 standard protocol corresponds to a second target port 2001, the Document 575 standard protocol corresponds to a second target port 2002, the Document 630 standard protocol corresponds to a second target port 3003, the Document 630 standard protocol may also be interconnected and interworked with the second target port 2001 corresponding to the Document 71 standard protocol in an interface plus protocol converter mode.

In some exemplary embodiments, the interconnection and interworking process between the core node and the regional node mainly includes: a process of the regional node registering to the core node, a process of the regional node reporting resource information to the core node, and a process of the core node issuing a control instruction to the regional node. These processes are described in detail below.

(I). The process of the regional node registering to the core node.

In some exemplary embodiments, according to the preset first correspondence relationship between ports and protocol versions and by means of a second target port, implementing interconnection and interworking with the core node having a second management unit by adopting the protocol version corresponding to the core node includes: by means of the second target port, sending a second registration request to the core node by adopting the protocol version corresponding to the core node, where the second registration request includes: information of the regional node; and by means of the second target port, receiving a second registration success response or a second registration failure response sent from the core node by adopting the protocol version corresponding to the core node.

In some exemplary embodiments, the second registration request includes an SIP header, and a second message body containing information of the regional node. In some exemplary embodiments, the SIP header includes a destination port, i.e., the second target port.

In some exemplary embodiments, the second message body further includes: a message body version, an encoding mode, and information about whether the second message body is independent.

In some exemplary embodiments, the information of the regional node includes: an identification of the regional node, an internet protocol address of the regional node, a port number of the regional node, a node name of the regional node, and a password of the regional node.

In some exemplary embodiments, the information of the regional node further includes at least one of: a manufacturer identification, a manufacturer name, a protocol version, or a software version of the regional node.

(II). The process of the core node issuing a control instruction to the regional node.

In some exemplary embodiments, according to the preset first correspondence relationship between ports and protocol versions and by means of a second target port, implementing interconnection and interworking with the core node having a second management unit by adopting the protocol version corresponding to the core node includes: by means of the second target port, receiving a control instruction issued by the core node by adopting the protocol version corresponding to the core node, where the control instruction includes: an identification of the first-level access node.

In some exemplary embodiments, the control instruction includes at least one of: a video request type instruction, a cloud mirror control type instruction, or a video playing control type instruction.

(III). The process of the regional node reporting resource information to the core node.

In some exemplary embodiments, according to the preset first correspondence relationship between ports and protocol versions and by means of a second target port, implementing interconnection and interworking with the core node having a second management unit by adopting the protocol version corresponding to the core node includes: by means of the second target port, sending a second resource reporting request to the core node by adopting the protocol version corresponding to the core node, where the second resource reporting request includes: an identification of the regional node, and resource information of a second-level access node corresponding to a first-level access node corresponding to the regional node; and by means of the second target port, receiving a second reporting success response sent from the core node by adopting the protocol version corresponding to the core node.

In some exemplary embodiments, the second resource reporting request includes: a SIP header and a fourth message body.

In some exemplary embodiments, the fourth message body includes: an identification of the regional node, and resource information of a second-level access node corresponding to a first-level access node corresponding to the regional node.

In some exemplary embodiments, the fourth message body further includes: a message body version, an encoding mode, and information about whether the fourth message body is independent.

In some exemplary embodiments, the fourth message body further includes: a total number of packets and a current number of packets.

In some exemplary embodiments, the fourth message body may include resource information of one second-level access node, or may include resource information of two or more second-level access nodes.

In some exemplary embodiments, the resource information of the second-level access node includes: a resource identification, a resource name, resource installation position information in the second-level access node, use information of the second-level access node, and remark information of the second-level access node.

In some exemplary embodiments, the first-level access node corresponding to the regional node refers to a first-level access node which has registered to the regional node.

In some exemplary embodiments, the second-level access node corresponding to the first-level access node refers to a second-level access node connected to the first-level access node.

In some exemplary embodiments, the second-level access node may be a camera or the like.

In some exemplary embodiments, the resource of the second-level access node may be at least one of a camera resource, a user resource, or an alert resource.

Based on a first correspondence relationship between ports and protocol versions and by means of a first target port having the first correspondence relationship with a protocol version corresponding to a first-level access node, the method for implementing interconnection and interworking provided in the embodiment of the present disclosure implements interconnection and interworking between the first-level access node and the regional node by adopting a protocol version corresponding to the first-level access node, which means that the interconnection and interworking between a first-level access node and a regional node of different protocol versions can be implemented by adopting different protocol versions corresponding to different ports. Likewise, based on the first correspondence relationship between ports and protocol versions and by means of a second target port having the first correspondence relationship with a protocol version corresponding to a core node, the method of the present disclosure implements interconnection and interworking between the core node and the regional node by adopting a protocol version corresponding to the core node, which means that the interconnection and interworking between a core node and a regional node of different protocol versions can be implemented by adopting different protocol versions corresponding to different ports. Therefore, compared with the interface plus protocol converter mode, the method of the present disclosure does not need any other additional interface service module or protocol conversion module, or any other additional dedicated device, so that in terms of development and maintenance, development of the system can be ensured to be available, the research, development, operation and maintenance cost is reduced, and the management and maintenance of the protocol version are facilitated. Further, the number of intermediate modules is reduced, that is, the equipment investment cost is reduced, while the reduced number of intermediate modules means reduced fault points and reduced problem troubleshooting links, so that a problem can be located quickly. Further, a peer-to-peer protocol version can be selected autonomously to realize the function of cascaded connection, thereby reducing the influence of the constrained cascaded position and enabling higher adaptability. Further, timely response of the system is improved while the engineering deployment complexity is reduced, the user experience is greatly improved, and a good foundation is laid for an intelligent video surveillance system in the future.

FIG. 4 is a flowchart of a method for implementing interconnection and interworking applied to a first-level access node according to another embodiment of the present disclosure.

In a second aspect, referring to FIG. 4, another embodiment of the present disclosure provides a method for implementing interconnection and interworking, which is applied to a first-level access node and includes the following step 400.

At step 400, implementing interconnection and interworking with a first target port of a regional node having a first management unit by adopting a protocol version corresponding to the first-level access node, where the first target port is a port having the first correspondence relationship with the protocol version corresponding to the first-level access node; and the first correspondence relationship is a correspondence relationship between ports and protocol versions of the regional node.

In some exemplary embodiments, the protocol version may be at least one of: Document 71 standard protocol, Document 575 standard protocol, or Document 630 standard protocol. For example, the Document 71 standard protocol corresponds to a first target port 1001, the Document 575 standard protocol corresponds to a first target port 1002, the Document 630 standard protocol corresponds to a first target port 1003, and the Document 630 standard protocol may also be interconnected and interworked with the first target port 1001 corresponding to the Document 71 standard protocol in an interface plus protocol converter mode.

In some exemplary embodiments, the interconnection and interworking process between the first-level access node and the regional node mainly includes: a process of the first-level access node registering to the regional node, a process of the first-level access node reporting resource information to the regional node, and a process of the regional node issuing a control instruction to the first-level access node. These processes are described in detail below.

(I). The process of the first-level access node registering to the regional node.

In some exemplary embodiments, implementing interconnection and interworking with the first target port of the regional node having a first management unit by adopting the protocol version corresponding to the first-level access node includes: sending a first registration request to the first target port of the regional node by adopting the protocol version corresponding to the first-level access node, where the first registration request includes: information of the first-level access node; and receiving a first registration success response or a first registration failure response sent from the first target port of the regional node by adopting the protocol version corresponding to the first-level access node.

In some exemplary embodiments, the first registration request includes an SIP header, and a first message body containing information of the first-level access node.

In some exemplary embodiments, the SIP header includes a destination port, i.e., the first target port.

In some exemplary embodiments, the first message body further includes: a message body version, an encoding mode, and information about whether the first message body is independent.

In some exemplary embodiments, the information of the first-level access node includes: an identification of the first-level access node, an IP address of the first-level access node, a port number of the first-level access node, a node name of the first-level access node, and a password of the first-level access node.

In some exemplary embodiments, the information of the first-level access node further includes at least one of: a manufacturer identification, a manufacturer name, a protocol version, or a software version of the first-level access node.

(II). The process of the regional node issuing a control instruction to the first-level access node.

In some exemplary embodiments, implementing interconnection and interworking with the first target port of the regional node having a first management unit by adopting the protocol version corresponding to the first-level access node includes: receiving a control instruction issued by the first target port of the regional node by adopting the protocol version corresponding to the first-level access node.

In some exemplary embodiments, the control instruction includes at least one of: a video request type instruction, a cloud mirror control type instruction, or a video playing control type instruction.

In some exemplary embodiments, implementing interconnection and interworking with the first target port of the regional node having a first management unit by adopting the protocol version corresponding to the first-level access node further includes: executing an operation corresponding to the control instruction after receiving the control instruction issued by the first target port of the regional node by adopting the protocol version corresponding to the first-level access node.

(III). The process of the first-level access node reporting resource information to the regional node.

In some exemplary embodiments, implementing interconnection and interworking with the first target port of the regional node having a first management unit by adopting the protocol version corresponding to the first-level access node includes: sending a first resource reporting request to the first target port of the regional node by adopting the protocol version corresponding to the first-level access node, where the first resource reporting request includes: an identification of the first-level access node, and resource information of a second-level access node corresponding to the first-level access node; and receiving a first reporting success response sent from the first target port of the regional node by adopting the protocol version corresponding to the first-level access node.

In some exemplary embodiments, the first resource reporting request includes: a SIP header and a third message body.

In some exemplary embodiments, the third message body includes: an identification of the first-level access node, and resource information of a second-level access node corresponding to the first-level access node.

In some exemplary embodiments, the third message body further includes: a message body version, an encoding mode, and information about whether the third message body is independent.

In some exemplary embodiments, the third message body further includes: a total number of packets and a current number of packets.

In some exemplary embodiments, the third message body may include resource information of one second-level access node, or may include resource information of two or more second-level access nodes.

In some exemplary embodiments, the resource information of the second-level access node includes: a resource identification, a resource name, resource installation position information in the second-level access node, use information of the second-level access node, and remark information of the second-level access node.

In some exemplary embodiments, the second-level access node corresponding to the first-level access node refers to a second-level access node connected to the first-level access node.

In some exemplary embodiments, the second-level access node may be a camera or the like.

In some exemplary embodiments, the resource of the second-level access node may be at least one of a camera resource, a user resource, or an alert resource.

Based on a first correspondence relationship between ports and protocol versions and by means of a first target port having the first correspondence relationship with a protocol version corresponding to a first-level access node, the method for implementing interconnection and interworking provided in the embodiment of the present disclosure implements interconnection and interworking between the first-level access node and the regional node by adopting a protocol version corresponding to the first-level access node, which means that the interconnection and interworking between a first-level access node and a regional node of different protocol versions can be implemented by adopting different protocol versions corresponding to different ports. Therefore, compared with the interface plus protocol converter mode, the method of the present disclosure does not need any other additional interface service module or protocol conversion module, or any other additional dedicated device, so that in terms of development and maintenance, development of the system can be ensured to be available, the research, development, operation and maintenance cost is reduced, and the management and maintenance of the protocol version are facilitated. Further, the number of intermediate modules is reduced, that is, the equipment investment cost is reduced, while the reduced number of intermediate modules means reduced fault points and reduced problem troubleshooting links, so that a problem can be located quickly. Further, a peer-to-peer protocol version can be selected autonomously to realize the function of cascaded connection, thereby reducing the influence of the constrained cascaded position and enabling higher adaptability. Further, timely response of the system is improved while the engineering deployment complexity is reduced, the user experience is greatly improved, and a good foundation is laid for an intelligent video surveillance system in the future.

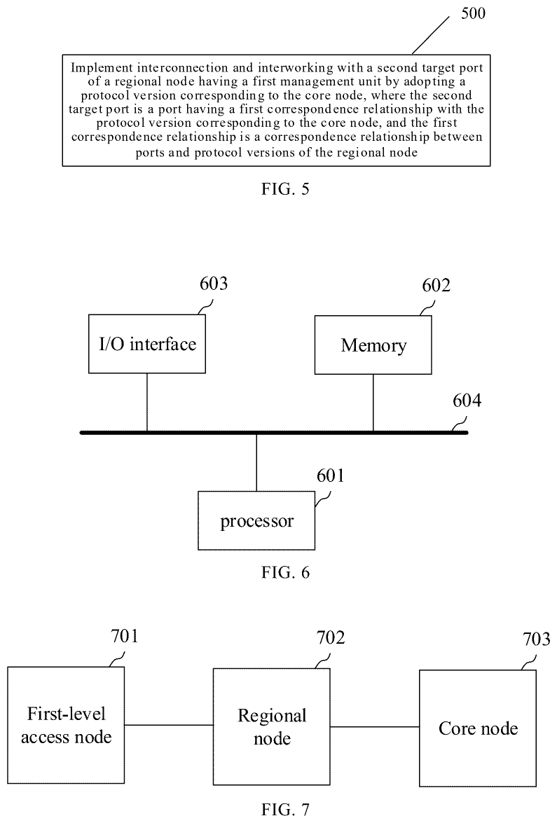

FIG. 5 is a flowchart of a method for implementing interconnection and interworking applied to a core node having a second management unit according to another embodiment of the present disclosure.

In a third aspect, referring to FIG. 5, another embodiment of the present disclosure provides a method for implementing interconnection and interworking, which is applied to a core node having a second management unit and includes the following step 500.

At step 500, implementing interconnection and interworking with a second target port of a regional node having a first management unit by adopting a protocol version corresponding to the core node, where the second target port is a port having a first correspondence relationship with the protocol version corresponding to the core node, and the first correspondence relationship is a correspondence relationship between ports and protocol versions of the regional node.

In some exemplary embodiments, the protocol version may be at least one of: Document 71 standard protocol, Document 575 standard protocol, or Document 630 standard protocol. For example, the Document 71 standard protocol corresponds to a second target port 2001, the Document 575 standard protocol corresponds to a second target port 2002, the Document 630 standard protocol corresponds to a second target port 3003, the Document 630 standard protocol may also be interconnected and interworked with the second target port 2001 corresponding to the Document 71 standard protocol in an interface plus protocol converter mode.

In some exemplary embodiments, the interconnection and interworking process between the core node and the regional node mainly includes: a process of the regional node registering to the core node, a process of the regional node reporting resource information to the core node, and a process of the core node issuing a control instruction to the regional node. These processes are described in detail below.

(I). The process of the regional node registering to the core node.

In some exemplary embodiments, implementing interconnection and interworking with the second target port of the regional node having a first management unit by adopting the protocol version corresponding to the core node includes: receiving a second registration request sent from the second target port of the regional node by adopting the protocol version corresponding to the core node, where the second registration request includes: information of the regional node; checking the information of the regional node; under the condition that the checking is passed, storing a fourth correspondence relationship between the information of the regional node and the second target port; and by means of the second target port, returning a second registration success response to the core node by adopting the protocol version corresponding to the core node.

In some exemplary embodiments, the second registration request includes an SIP header, and a second message body containing information of the regional node.

In some exemplary embodiments, the SIP header includes a destination port, i.e., the second target port.

In some exemplary embodiments, the second message body further includes: a message body version, an encoding mode, and information about whether the second message body is independent.

In some exemplary embodiments, the information of the regional node includes: an identification of the regional node, an internet protocol address of the regional node, a port number of the regional node, a node name of the regional node, and a password of the regional node.

In some exemplary embodiments, the information of the regional node further includes at least one of: a manufacturer identification, a manufacturer name, a protocol version, or a software version of the regional node.

In some exemplary embodiments, checking the information of the regional node includes: under the condition that information allocated to the regional node is the same as the information of the regional node in the second registration request, determining that the checking is passed; and under the condition that information allocated to the regional node is not the same as the information of the regional node in the second registration request, determining that the checking is not passed.

In some exemplary embodiments, the information allocated to the regional node includes: an identification allocated to the regional node, an IP address allocated to the regional node, a port number allocated to the regional node, a node name allocated to the regional node, and a password allocated to the regional node.

In some exemplary embodiments, the condition that information allocated to the regional node is the same as the information of the regional node in the second registration request includes: the identification allocated to the regional node is the same as the identification of the regional node in the information of the regional node contained in the second registration request, the IP address allocated to the regional node is the same as the IP address of the regional node in the information of the regional node contained in the second registration request, the port number allocated to the regional node is the same as the port number of the regional node in the information of the regional node contained in the second registration request, the node name allocated to the regional node is the same as the node name of the regional node in the information of the regional node contained in the second registration request, and the password allocated to the regional node is the same as the password of the regional node in the information of the regional node contained in the second registration request.

In some exemplary embodiments, the condition that information allocated to the regional node is not the same as the information of the regional node in the second registration request includes: the identification allocated to the regional node is not the same as the identification of the regional node in the information of the regional node contained in the second registration request, or the IP address allocated to the regional node is not the same as the IP address of the regional node in the information of the regional node contained in the second registration request, or the port number allocated to the regional node is not the same as the port number of the regional node in the information of the regional node contained in the second registration request, or the node name allocated to the regional node is not the same as the node name of the regional node in the information of the regional node contained in the second registration request, or the password allocated to the regional node is not the same as the password of the regional node in the information of the regional node contained in the second registration request.

In some exemplary embodiments, the second registration success response includes: a keep-alive period.

(II). The process of the core node issuing a control instruction to the regional node.

In some exemplary embodiments, implementing interconnection and interworking with the second target port of the regional node having a first management unit by adopting the protocol version corresponding to the core node includes: determining the regional node according to a preset fifth correspondence relationship between first-level access nodes and regional nodes; and issuing a control instruction to the second target port of the regional node by adopting the protocol version corresponding to the core node, where the control instruction includes: an identification of the first-level access node.

In some exemplary embodiments, the control instruction includes at least one of: a video request type instruction, a cloud mirror control type instruction, or a video playing control type instruction.

(III). The process of the regional node reporting resource information to the core node.

In some exemplary embodiments, implementing interconnection and interworking with the second target port of the regional node having a first management unit by adopting the protocol version corresponding to the core node includes: receiving a second resource reporting request sent from the second target port of the regional node by adopting the protocol version corresponding to the core node, where the second resource reporting request includes: an identification of the regional node, and resource information of a second-level access node corresponding to a first-level access node corresponding to the regional node; storing a sixth correspondence relationship between the identification of the regional node and the resource information of the second-level access node corresponding to the first-level access node corresponding to the regional node; and sending a second reporting success response to the second target port of the regional node by adopting the protocol version corresponding to the core node.

In some exemplary embodiments, the second resource reporting request includes: an SIP header and a fourth message body.

In some exemplary embodiments, the fourth message body includes: an identification of the regional node, and resource information of a second-level access node corresponding to a first-level access node corresponding to the regional node.

In some exemplary embodiments, the fourth message body further includes: a message body version, an encoding mode, and information about whether the fourth message body is independent.

In some exemplary embodiments, the fourth message body further includes: a total number of packets and a current number of packets.

In some exemplary embodiments, the fourth message body may include resource information of one second-level access node, or may include resource information of two or more second-level access nodes.

In some exemplary embodiments, the resource information of the second-level access node includes: a resource identification, a resource name, resource installation position information in the second-level access node, use information of the second-level access node, and remark information of the second-level access node.

In some exemplary embodiments, the first-level access node corresponding to the regional node refers to a first-level access node which has registered to the regional node.

In some exemplary embodiments, the second-level access node corresponding to the first-level access node refers to a second-level access node connected to the first-level access node.

In some exemplary embodiments, the second-level access node may be a camera or the like.

In some exemplary embodiments, the resource of the second-level access node may be at least one of a camera resource, a user resource, or an alert resource.

Based on the first correspondence relationship between ports and protocol versions and by means of a second target port having the first correspondence relationship with a protocol version corresponding to a core node, the method for implementing interconnection and interworking provided in the embodiment of the present disclosure implements interconnection and interworking between the core node and the regional node by adopting a protocol version corresponding to the core node, which means that the interconnection and interworking between a core node and a regional node of different protocol versions can be implemented by adopting different protocol versions corresponding to different ports. Therefore, compared with the interface plus protocol converter mode, the method of the present disclosure does not need any other additional interface service module or protocol conversion module, or any other additional dedicated device, so that in terms of development and maintenance, development of the system can be ensured to be available, the research, development, operation and maintenance cost is reduced, and the management and maintenance of the protocol version are facilitated. Further, the number of intermediate modules is reduced, that is, the equipment investment cost is reduced, while the reduced number of intermediate modules means reduced fault points and reduced problem troubleshooting links, so that a problem can be located quickly. Further, a peer-to-peer protocol version can be selected autonomously to realize the function of cascaded connection, thereby reducing the influence of the constrained cascaded position and enabling higher adaptability. Further, timely response of the system is improved while the engineering deployment complexity is reduced, the user experience is greatly improved, and a good foundation is laid for an intelligent video surveillance system in the future.

In a fourth aspect, referring to FIG. 6, another embodiment of the present application provides an electronic device, including: at least one processor 601; and a memory 602 having at least one program stored thereon which, when executed by the at least one processor 601, causes any method for implementing interconnection and interworking as described above to be implemented.

In some exemplary embodiments, the electronic device further includes: one or more I/O interfaces 603 connected between the processor 601 and the memory 602 and configured to enable information interaction between the processor 601 and the memory 602.

The processor 601 is a device with a data processing capability, including but not limited to a central processing unit (CPU), or the like. The memory 602 is a device with a data storage capability, including but not limited to, a random access memory (RAM, more specifically SDRAM, DDR, etc.), a read-only memory (ROM), an electrically erasable programmable read-only memory (EEPROM) or a flash memory (FLASH). The I/O interface (read/write interface) 603 is connected between the processor 601 and the memory 602 to enable information interaction between the processor 601 and the memory 602, and includes, but is not limited to, a bus or the like.

In some embodiments, the processor 601, the memory 602, and the I/O interface 603 are interconnected via a bus 604, and further connected to other components of a computing device.

In a fifth aspect, another embodiment of the present disclosure provides a computer-readable medium having a computer program stored thereon which, when executed by a processor, causes any method for implementing interconnection and interworking as described above to be implemented.

FIG. 7 is a block diagram of a system for implementing interconnection and interworking according to another embodiment of the present disclosure.

In a sixth aspect, referring to FIG. 7, another embodiment of the present disclosure provides a system for implementing interconnection and interworking, including: a first-level access node 701, a regional node 702 having a first management unit, and a core node 703 having a second management unit.

The first-level access node 701 is configured to implement interconnection and interworking with a first target port of a regional node having a first management unit by adopting a protocol version corresponding to the first-level access node, where the first target port is a port having the first correspondence relationship with the protocol version corresponding to the first-level access node; and the first correspondence relationship is a correspondence relationship between ports and protocol versions of the regional node.

The regional node 702 is configured to according to a preset first correspondence relationship between ports and protocol versions and by means of a first target port, implement interconnection and interworking with a first-level access node by adopting a protocol version corresponding to the first-level access node, where the first target port is a port having the first correspondence relationship with the protocol version corresponding to the first-level access node; and according to the preset first correspondence relationship between ports and protocol versions and by means of a second target port, implement interconnection and interworking with a core node having a second management unit by adopting a protocol version corresponding to the core node, where the second target port is a port having the first correspondence relationship with the protocol version corresponding to the core node.

The core node 703 is configured to implement interconnection and interworking with a second target port of a regional node having a first management unit by adopting a protocol version corresponding to the core node, where the second target port is a port having a first correspondence relationship with the protocol version corresponding to the core node, and the first correspondence relationship is a correspondence relationship between ports and protocol versions of the regional node.

The specific implementation process of the system for implementing interconnection and interworking is the same as that of the method for implementing interconnection and interworking described in the foregoing embodiments, and thus is not repeated here.

Those of ordinary skill in the art will appreciate that all or some operations of the above described method, functional modules/units in the system and apparatus may be implemented as software, firmware, hardware, and suitable combinations thereof. In a hardware implementation, the division between the functional modules/units mentioned in the above description does not necessarily correspond to the division of physical components; for example, one physical component may have multiple functions, or one function or operation may be performed cooperatively by several physical components. Some or all physical components may be implemented as software executed by a processor, such as a CPU, a digital signal processor or microprocessor, or implemented as hardware, or implemented as an integrated circuit, such as an application specific integrated circuit. Such software may be distributed on a computer-readable medium which may include a computer storage medium (or non-transitory medium) and a communication medium (or transitory medium). As is well known to those of ordinary skill in the art, the term computer storage medium includes volatile and nonvolatile, removable and non-removable medium implemented in any method or technology for storing information, such as computer-readable instructions, data structures, program modules or other data. The computer storage medium includes, but is not limited to, an RAM, an ROM, an EEPROM, a flash or any other memory technology, a CD-ROM, a digital versatile disk (DVD) or any other optical disk storage, a magnetic cartridge, a magnetic tape, a magnetic disk storage or any other magnetic memory, or may be any other medium used for storing the desired information and accessible by a computer. Moreover, it is well known to those ordinary skilled in the art that a communication medium typically includes a computer-readable instruction, a data structure, a program module, or other data in a modulated data signal, such as a carrier wave or other transport mechanism, and may include any information delivery medium.

The present disclosure has disclosed exemplary embodiments, and although specific terms are employed, they are used and should be interpreted merely in a generic and descriptive sense, not for purposes of limitation. In some instances, as would be apparent to one skilled in the art, features, characteristics and/or elements described in connection with a particular embodiment may be used alone or in combination with features, characteristics and/or elements described in connection with another embodiment, unless expressly stated otherwise. It will, therefore, be understood by those skilled in the art that various changes in form and details may be made therein without departing from the scope of the present disclosure as set forth in the appended claims.

1. A method for implementing interconnection and interworking, which is applied to a regional node having a first management unit and comprises:
according to a preset first correspondence relationship between ports and protocol versions and by means of a first target port, implementing interconnection and interworking with a first-level access node by adopting a protocol version corresponding to the first-level access node, wherein the first target port is a port having the first correspondence relationship with the protocol version corresponding to the first-level access node; and
according to the preset first correspondence relationship between the ports and the protocol versions and by means of a second target port, implementing interconnection and interworking with a core node having a second management unit by adopting a protocol version corresponding to the core node, wherein the second target port is a port having the first correspondence relationship with the protocol version corresponding to the core node.

2. The method for implementing interconnection and interworking according to claim 1, wherein according to the preset first correspondence relationship between the ports and the protocol versions and by means of the first target port, implementing interconnection and interworking with the first-level access node by adopting the protocol version corresponding to the first-level access node comprises:
by means of the first target port, receiving a first registration request sent from the first-level access node by adopting the protocol version corresponding to the first-level access node, wherein the first registration request comprises: information of the first-level access node;
checking the information of the first-level access node;
under the condition that the checking is passed, storing a second correspondence relationship between the information of the first-level access node and the first target port; and
by means of the first target port, returning a first registration success response to the first-level access node by adopting the protocol version corresponding to the first-level access node.

3. The method for implementing interconnection and interworking according to claim 2, wherein the information of the first-level access node comprises: an identification of the first-level access node, an internet protocol address of the first-level access node, a port number of the first-level access node, a node name of the first-level access node, and a password of the first-level access node.

4. The method for implementing interconnection and interworking according to claim 1, wherein according to the preset first correspondence relationship between the ports and the protocol versions and by means of the second target port, implementing interconnection and interworking with the core node having the second management unit by adopting the protocol version corresponding to the core node comprises:
by means of the second target port, sending a second registration request to the core node by adopting the protocol version corresponding to the core node, wherein the second registration request comprises: information of the regional node; and
by means of the second target port, receiving a second registration success response or a second registration failure response sent from the core node by adopting the protocol version corresponding to the core node.

5. The method for implementing interconnection and interworking according to claim 4, wherein the information of the regional node comprises: an identification of the regional node, an internet protocol address of the regional node, a port number of the regional node, a node name of the regional node, and a password of the regional node.

6. The method for implementing interconnection and interworking according to claim 12, wherein according to the preset first correspondence relationship between the ports and the protocol versions and by means of the second target port, implementing interconnection and interworking with the core node having the second management unit by adopting the protocol version corresponding to the core node comprises: by means of the second target port, receiving a control instruction issued by the core node by adopting the protocol version corresponding to the core node, wherein the control instruction comprises: an identification of the first-level access node; and
according to the preset first correspondence relationship between the ports and the protocol versions and by means of the first target port, implementing interconnection and interworking with the first-level access node by adopting the protocol version corresponding to the first-level access node comprises: searching, in the pre-stored second correspondence relationship between the information of the first-level access node and the first target port, for a first target port corresponding to the information of the first-level access node comprising the identification of the first-level access node, and by means of the found first target port, issuing the control instruction to the first-level access node corresponding to the information of the first-level access node comprising the identification of the first-level access node by adopting a protocol version having the first correspondence relationship with the found first target port.

7. The method for implementing interconnection and interworking according to claim 1, wherein according to the preset first correspondence relationship between the ports and the protocol versions and by means of the first target port, implementing interconnection and interworking with the first-level access node by adopting the protocol version corresponding to the first-level access node comprises:
by means of the first target port, receiving a first resource reporting request sent from the first-level access node by adopting the protocol version corresponding to the first-level access node, wherein the first resource reporting request comprises: an identification of the first-level access node, and resource information of a second-level access node corresponding to the first-level access node;
storing a third correspondence relationship between the identification of the first-level access node and the resource information of the second-level access node corresponding to the first-level access node; and
by means of the first target port, sending a first reporting success response to the first-level access node by adopting the protocol version corresponding to the first-level access node.

8. The method for implementing interconnection and interworking according to claim 1, wherein according to the preset first correspondence relationship between the ports and the protocol versions and by means of the second target port, implementing interconnection and interworking with the core node having the second management unit by adopting the protocol version corresponding to the core node comprises:
by means of the second target port, sending a second resource reporting request to the core node by adopting the protocol version corresponding to the core node, wherein the second resource reporting request comprises: an identification of the regional node, and resource information of a second-level access node corresponding to a first-level access node corresponding to the regional node; and
by means of the second target port, receiving a second reporting success response sent from the core node by adopting the protocol version corresponding to the core node.

9. A method for implementing interconnection and interworking, which is applied to a first-level access node and comprises:
implementing interconnection and interworking with a first target port of a regional node having a first management unit by adopting a protocol version corresponding to the first-level access node, wherein the first target port is a port having a first correspondence relationship with the protocol version corresponding to the first-level access node, and the first correspondence relationship is a correspondence relationship between ports and protocol versions of the regional node.

10. The method for implementing interconnection and interworking according to claim 9, wherein implementing interconnection and interworking with the first target port of the regional node having the first management unit by adopting the protocol version corresponding to the first-level access node comprises:
sending a first registration request to the first target port of the regional node by adopting the protocol version corresponding to the first-level access node, wherein the first registration request comprises: information of the first-level access node; and
receiving a first registration success response or a first registration failure response sent from the first target port of the regional node by adopting the protocol version corresponding to the first-level access node.

11. The method for implementing interconnection and interworking according to claim 9, wherein implementing interconnection and interworking with the first target port of the regional node having the first management unit by adopting the protocol version corresponding to the first-level access node comprises:
receiving a control instruction issued by the first target port of the regional node by adopting the protocol version corresponding to the first-level access node.

12. The method for implementing interconnection and interworking according to claim 9, wherein implementing interconnection and interworking with the first target port of the regional node having the first management unit by adopting the protocol version corresponding to the first-level access node comprises:
sending a first resource reporting request to the first target port of the regional node by adopting the protocol version corresponding to the first-level access node, wherein the first resource reporting request comprises: an identification of the first-level access node, and resource information of a second-level access node corresponding to the first-level access node; and
receiving a first reporting success response sent from the first target port of the regional node by adopting the protocol version corresponding to the first-level access node.

13. A method for implementing interconnection and interworking, which is applied to a core node having a second management unit and comprises:
implementing interconnection and interworking with a second target port of a regional node having a first management unit by adopting a protocol version corresponding to the core node, wherein the second target port is a port having a first correspondence relationship with the protocol version corresponding to the core node, and the first correspondence relationship is a correspondence relationship between ports and protocol versions of the regional node.

14. The method for implementing interconnection and interworking according to claim 13, wherein implementing interconnection and interworking with the second target port of the regional node having the first management unit by adopting the protocol version corresponding to the core node comprises:
receiving a second registration request sent from the second target port of the regional node by adopting the protocol version corresponding to the core node, wherein the second registration request comprises: information of the regional node;
checking the information of the regional node;
under the condition that the checking is passed, storing a fourth correspondence relationship between the information of the regional node and the second target port; and
by means of the second target port, returning a second registration success response to the core node by adopting the protocol version corresponding to the core node.

15. The method for implementing interconnection and interworking according to claim 13, wherein implementing interconnection and interworking with the second target port of the regional node having the first management unit by adopting the protocol version corresponding to the core node comprises:
determining the regional node according to a preset fifth correspondence relationship between first-level access nodes and regional nodes; and
issuing a control instruction to the second target port of the regional node by adopting the protocol version corresponding to the core node, wherein the control instruction comprises: an identification of the first-level access node.

16. The method for implementing interconnection and interworking according to claim 13, wherein implementing interconnection and interworking with the second target port of the regional node having a first management unit by adopting the protocol version corresponding to the core node comprises:
receiving a second resource reporting request sent from the second target port of the regional node by adopting the protocol version corresponding to the core node, wherein the second resource reporting request comprises: an identification of the regional node, and resource information of a second-level access node corresponding to a first-level access node corresponding to the regional node;
storing a sixth correspondence relationship between the identification of the regional node and the resource information of the second-level access node corresponding to the first-level access node corresponding to the regional node; and
sending a second reporting success response to the second target port of the regional node by adopting the protocol version corresponding to the core node.

17. An electronic device, comprising:
at least one processor; and
a memory having at least one program stored thereon which, when executed by the at least one processor, causes the at least one processor to implement the method for implementing interconnection and interworking according to claim 1.

18. A computer-readable medium having a computer program stored thereon which, when executed by a processor, causes the method for implementing interconnection and interworking according to claim 1 to be implemented.
